(19) United States
(12) Patent Application Publication
(10) Pub. No.: US 2018/0200981 A1
(43) Pub. Date: Jul. 19, 2018

(54) HEAT INSULATION PRODUCT

(71) Applicant: Zipper-Technik GmbH, Neu-Isenburg (DE)

(72) Inventors: Frank REUSSWIG, Freigericht (DE); Sean PLUMMER, Gilberg, AZ (US)

(21) Appl. No.: 15/743,751

(22) PCT Filed: Jul. 12, 2016
(86) PCT No.: PCT/EP2016/066542

§ 371 Date: Jan. 11, 2018

(30) Foreign Application Priority Data
Jul. 14, 2015 (EP) 15176690.9

(51) Int. Cl. B32B 1/08; B32B 5/02; B32B 15/08; B60R 13/08

(52) U.S. Cl. CPC B32B 1/08; B32B 5/024; B32B 5/026; B32B 5/028; B60Y 2410/114; B60R 13/0876; B32B 2605/00; B32B 2307/304; B32B 15/08

(57) ABSTRACT

A heat protection product with at least one seam, comprising at least
a textile layer of polymer fibers from a thermoplastic material;
a polymer layer;
a metal layer;

wherein said at least one seam is obtained by welding.

The present invention relates to a heat protection product, and to a process for producing it. Heat-shielding or heat-protecting products are employed, for example, in the motor vehicle field. They are used for protecting temperature-sensitive components (for example, sensors, cables, flexible tubes, connectors, electronic elements) from the waste heat of other components (for example, the exhaust systems), or for protecting a media passed through a per se heat-resistant component.

DE 197 55 314, for example, describes such a component.

In many cases, the corresponding heat protection products must take defined shapes in order to enclose the temperature-sensitive components. Seams and rivets are usually used for this purpose. It is found that corresponding products have different insulation properties at these junctions. In particular, these sites may also be permeable to water and/or air. Therefore, there is a need for elements that have improved seams.

It is the object of the present invention to produce improved heat protection products. This object is achieved by a heat protection product with at least one seam, comprising at least
a textile layer of polymer fibers from a thermoplastic material;
a polymer layer;
a metal layer;

wherein said at least one seam is obtained by welding.

Thus, according to the invention, a heat protection product having a textile layer of polymer fibers from a thermoplastic material is provided. Suitable polymers include, in particular, polyesters, polyolefins, such as polyethylene or polypropylene, polyacrylonitriles, polyamides, polysulfonamides, and mixtures and copolymers thereof. Fibers of different polymers may also be mixed together in such a textile layer.

The textile layer may be a woven fabric, a loop-formingly or loop-drawingly knitted fabric, structured fabric, non-woven scrim. Preferably, it is a felt.

It has proven sufficient if the thickness of the textile layer is within a range of from about 1 to 10 mm.

Further, the heat protection product includes another polymer layer. For this layer, in particular, polyolefins, polyesters, acrylonitrile-butadiene-styrene (ABS), and mixtures thereof have proven suitable.

Preferred polyesters include polyethylene terephthalates, and preferred polyolefins include polyethylene, polypropylene, poly(vinyl chloride), and mixtures and copolymers thereof.

The term “copolymers” as used in this application also includes polymers of more than two monomers.

For example, the polymer layer may take the form of a polymer sheet.

Further, the heat protection product includes a metal layer; this may be a metal foil, or a film applied by vapor deposition.

In one embodiment, the product has the following layer structure:
a textile layer of polymer fibers from a thermoplastic material;
a polymer layer with a metal film applied by vapor deposition.

In another embodiment, the structure includes:
a textile layer of polymer fibers from a thermoplastic material;
a metal foil;
a polymer layer with a metal film applied by vapor deposition.

In structures in which a vapor-deposited film of the metal is present on the polymer sheet, such vapor-deposited film may be present on one or both sides.

Preferably, the structure is such that the textile layer of polymer fibers from a thermo-plastic material is on one side, and a vapor-deposited metal film is on the other side of the polymer sheet, which is subsequently formed into a heat protection product using a seam. Composite sheets including a metal layer and a polymer layer, which may optionally be metalized on one or both sides thereof, are commercially available. Typically, the thickness of such a composite sheet is from 15 to 50 μm. For example, the use of a 20 μm thick composite sheet including a 7 μm aluminum layer, a 1 μm adhesive layer and a 12 μm polymer layer is typical.

In the case of vapor-deposited metal films, the thickness is typically from 20 to 50 nm. Of course, the heat protection product may have further layers, for example, other metal or plastic layers, or layers of inorganic materials, such as glass fiber fabrics.

The bonding between the individual layers is typically effected by adhesive bonding; preferred adhesives include acrylates, polyurethanes and silicones.

Further, the heat protection product has at least one seam. A seam has the effect that the sheet structure takes a three-dimensional shape. The textile layer is welded to the textile layer.

Preferably, the heat protection product is tubular in shape.

Instead or preparing the seam from a sewing material or eyelets/rivets as in the prior art, it is prepared by welding in the present case. For example, ultrasonic welding, high frequency welding, hot air welding or friction welding are suitable as welding methods. This forms the thermoplastic material into a shape that allows the layer materials of the heat protection product to be welded together.

Unlike a seam prepared by eyelets, rivets or threads, the seams obtained according to the invention become substantially impermeable to water and air. The entry of water into heat protection elements can reduce the insulation effect considerably. Also, the entry of air may be disadvantageous because of convection.

The invention is further illustrated by means of the following Figures:

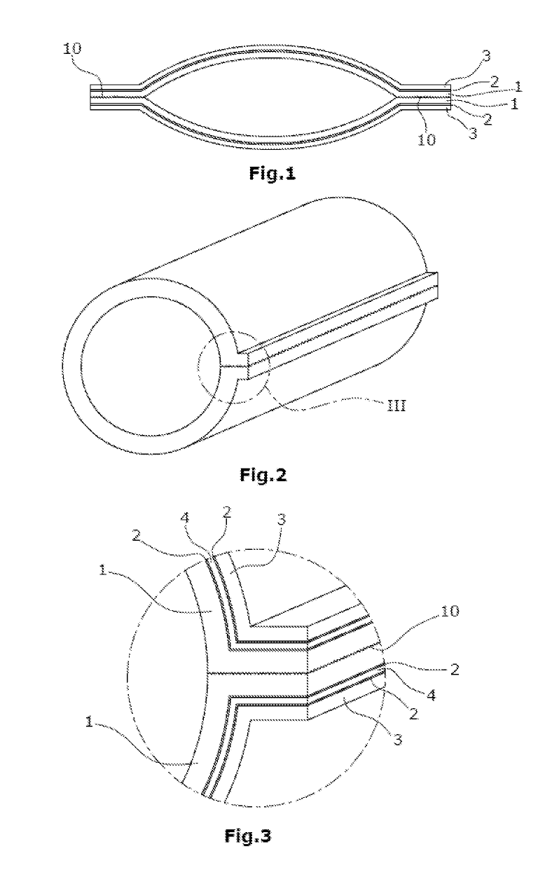

FIG. 1 shows a heat protection lay-flat hose. It is prepared by cutting a sheet material comprising a polyester felt 1, an adhesive 2 and a PET sheet 3 having a deposited aluminum film on both sides thereof into two webs, and then providing them with ultrasonic welding seams 10 on the sides thereof. Such heat protection lay-flat hoses can be produced continuously and are suitable, in particular, for the insulation of ribbon cables.

FIG. 2 shows a heat protection circular tube.

FIG. 3 shows the structure of the material of said heat protection circular tube. A polyester felt 1 is bonded through adhesive layers 2 to an aluminum foil 4 and a PET sheet 3 with a deposited aluminum film. The material is shaped into a hose and closed by a ultrasonic welding seam 10. Such a material is suitable, in particular, for the protection of cooling water hoses.

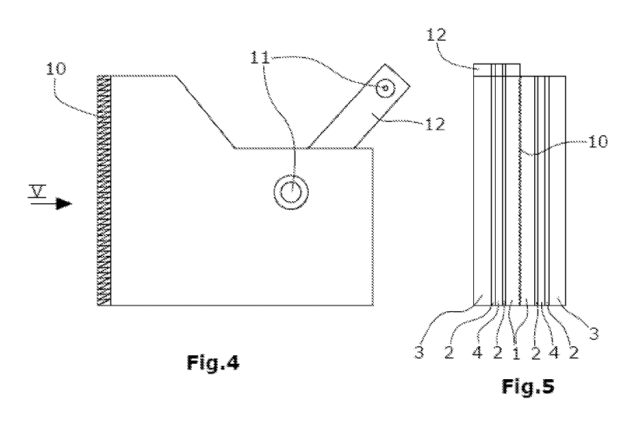

FIG. 4 shows a heat protection bag.

FIG. 5 shows a side view of said heat protection bag.

This bag is obtained from a material as described for FIG. 3 comprising a polyester felt, an aluminum foil and a PET sheet with a deposited aluminum film, which are mutually bonded together by an adhesive. These are joined together and provided with a welding seam 10.

The heat protection bag according to the invention also has a lap 12 that can be closed by means of a stainless steel push button 11. This can be used, for example, for thermally controlling connectors in automobiles for supplying media for SCR catalysts.

1. A heat protection product with at least one seam, comprising at least
a textile layer of polymer fibers from a thermoplastic material;
a polymer layer;
a metal layer;
wherein said at least one seam is obtained by welding.

2. The heat protection product according to claim 1, wherein said textile layer consists of organic polymer fibers.

3. The heat protection product according to claim 1, wherein said welding is ultrasonic welding, high frequency welding, hot air welding, or friction welding.

4. The heat protection product according to claim 2, wherein said polymer fibers of the textile layer are selected from the group consisting of polyesters, polyolefins, polyacrylonitriles, polyamides, polysulfonamides, and mixtures and copolymers thereof.

5. The heat protection product according to claim 1, wherein said textile layer is a woven fabric, a loop-formingly or loop-drawingly knitted fabric, a structured fabric, or a non-woven scrim, especially a felt.

6. The heat protection product according to claim 1, wherein the material of said polymer layer is selected from polyolefins, polyesters, acrylonitrile-butadiene-styrene (ABS), and mixtures and copolymers thereof.

7. The heat protection product according to claim 6, wherein said polyester is polyethylene terephthalate, and said polyolefin is polyethylene, polypropylene, or poly(vinyl chloride).

8. The heat protection product according to claim 1, wherein said polymer layer is a polymer sheet.

9. The heat protection product according to claim 1, wherein said metal layer is a metal foil, or has been applied by vapor deposition.

10. The heat protection product according to claim 1, wherein said heat protection product is tubular in shape.

11. The heat protection product according to claim 1, wherein the structure is as follows:
a polymer layer with a metal layer on one or both sides thereof;
a textile layer of polymer fibers from a thermoplastic material.

12. The heat protection product according to claim 1, wherein the structure is as follows:
a polymer layer with a metal layer on one or both sides thereof;
a metal foil;
a textile layer of polymer fibers from a thermoplastic material.

13. The heat protection product according to claim 1, wherein the structure is as follows:
a metal foil;
a polymer layer with a metal layer on one or both sides thereof;
a textile layer of polymer fibers from a thermoplastic material.

14. (canceled)
